(19) United States
(12) Patent Application Publication
(10) Pub. No.: US 2025/0108527 A1
(43) Pub. Date: Apr. 3, 2025

(54) Removable Blade Knife System

(71) Applicant: AOB Products Company, Columbia, MO (US)

(72) Inventors: Ryan Varnum, Columbia, MO (US); Michael Cottrell, Ashland, MO (US); James Tayon, Moberly, MO (US); Brian Steere, Columbia, MO (US); Timothy S. Kinney, Warrenton, MO (US); Jason Nickerson, Columbia, MO (US); Zach Smith, Columbia, MO (US)

(73) Assignee: AOB Products Company, Columbia, MO (US)

(21) Appl. No.: 18/904,559

(22) Filed: Oct. 2, 2024

Related U.S. Application Data
(60) Provisional application No. 63/587,352, filed on Oct. 2, 2023.

(51) Int. Cl. B26B 5/00; B26B 1/02

(52) U.S. Cl. CPC B26B 5/00; B26B 1/02

(57) ABSTRACT

A knife system including a blade, a blade support, and a blade tool. The blade includes a cutting edge, a blade connector, and a blade holder opening. The blade support includes a handle and a blade carrier. The blade carrier releasably connects to the blade connector to mount the blade to the blade support. The blade tool includes a blade tool compartment that receives the blade. The blade tool is able to flex the blade to enable the blade carrier to connect to the blade connector to mount the blade to the blade support and to disconnect from the blade connector to separate the blade and the blade support. The blade tool includes a blade holder receivable in the blade holder opening of the blade to prevent the blade from moving with the blade support when the blade carrier is connected to and disconnected from the blade.

### CROSS-REFERENCE TO RELATED APPLICATION

This application claims priority to U.S. Provisional Application No. 63/587,352, filed Oct. 2, 2023, the entirety of which is hereby incorporated by reference.

### FIELD

The present disclosure generally relates to knives, and more particularly to a knife having a handle and a blade selectively removable from the handle.

### BACKGROUND

Many types of knives are used for various tasks. Knives having different types of blades are used in different circumstances. A user may own a variety of knives having blades ranging from small to large in size, and having different blade features, such serration, flexibility, etc.

### SUMMARY

In one aspect, a knife system comprising a blade including a cutting edge, a blade connector, and a blade holder opening. A blade support includes a handle and a blade carrier. The blade carrier is configured to releasably connect to the blade connector of the blade to mount the blade to the blade support. A blade tool includes a blade tool compartment configured to receive the blade. The blade tool is configured to flex the blade to enable the blade carrier to connect to the blade connector of the blade to mount the blade to the blade support and to enable the blade carrier to disconnect from the blade connector of the blade to separate the blade and the blade support. The blade tool includes a blade holder sized and shaped to be received in the blade holder opening of the blade to prevent the blade from moving with the blade support when the blade carrier is connected to the blade and when the blade carrier is disconnected from the blade.

In another aspect, a knife comprising a blade support and a blade. The blade support includes a handle and a blade carrier. The blade carrier includes a key. A blade comprises a blade body having a proximal end portion and a distal end portion. The blade body is resiliently flexible. A cutting edge extends from the distal end portion toward the proximal end portion. A keyhole is defined by the blade body in the proximal end portion. The keyhole is sized and shaped to receive the key of the blade carrier to connect the blade to the blade support. A tab extends from the proximal end portion of the blade body. The tab is disposed on a cutting edge side of the blade. The tab is configured to be exposed when the blade is mounted to the blade support to enable a finger to press the tab to flex the blade for disconnecting the blade from the blade support.

In another aspect, a blade case comprises a housing having a blade tool compartment and a blade storage compartment separated by a web of the housing. The blade tool compartment is sized and shaped to store a plurality of blades. The blade tool compartment is sized and shaped to receive one of the blades of the plurality of blades. A first lid is supported by the housing and is configured to close the blade storage compartment. A second lid is supported by the housing and is configured to close the blade tool compartment. Blade engagement structure is configured to flex said one blade of the plurality of blades received in the blade tool compartment to enable a blade support to be connected to and disconnected from said one blade.

In another aspect, a blade for a knife comprises a blade body having a proximal end portion and a distal end portion. The blade body is resiliently flexible. A cutting edge extends from the distal end portion toward the proximal end portion. A keyhole is defined by the blade body in the proximal end portion. A blade holder opening is defined by the blade body. The blade holder opening is disposed along a length of the blade body between the keyhole and distal end portion of the blade body.

Other objects and features of the present disclosure will be in part apparent and in part pointed out herein.

### BRIEF DESCRIPTION OF THE DRAWINGS

FIG. 1 is a perspective of a knife system including a knife and a blade case;

FIG. 2 is a front elevation of the knife in an operational configuration;

FIG. 3 is a front elevation of the knife in a stowed configuration;

FIG. 4 is a front elevation of a blade support of the knife system;

FIG. 5 is an enlarged perspective of a blade carrier of the blade support;

FIG. 6 is a front elevation of a blade of the knife system;

FIG. 7 is a top perspective of the blade case, with covers in an open position;

FIG. 8 is a bottom perspective of the blade case, with covers in an open position;

FIG. 9 is a perspective of the knife system with the knife positioned in the blade case for changing the blade of the knife; and

FIG. 10 is fragmentary cross-section of the knife system in the configuration shown in FIG. 9.

Corresponding reference characters indicate corresponding parts throughout the drawings.

### DETAILED DESCRIPTION

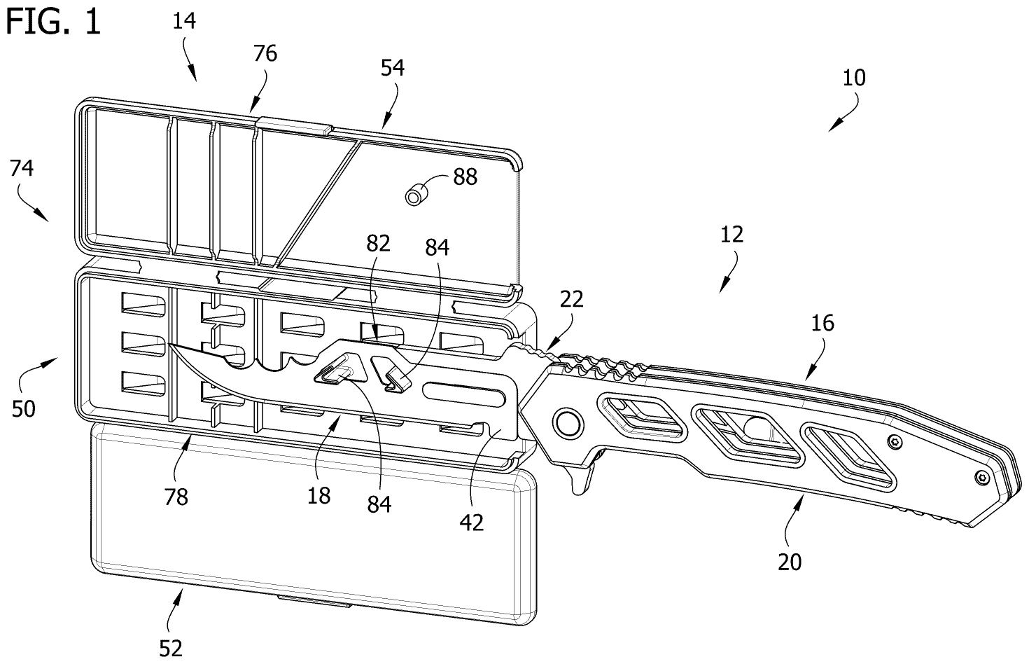

Referring to FIG. 1, a removable blade knife system or kit (“knife system” or “system”) according to one embodiment of the present disclosure is generally indicated by reference numeral 10. The knife system 10 includes a blade support 16 and a plurality of blades 18 interchangeably mountable on the blade support to form a knife 12. The knife system 10 also includes a dual-purpose blade case 14 for holding spare blades 18 and for use as a tool for changing the blade of the knife 12 (installing a blade on and removing a blade from the blade support 16). Aspects of the present disclosure can be incorporated in other embodiments without departing from the scope of the present disclosure

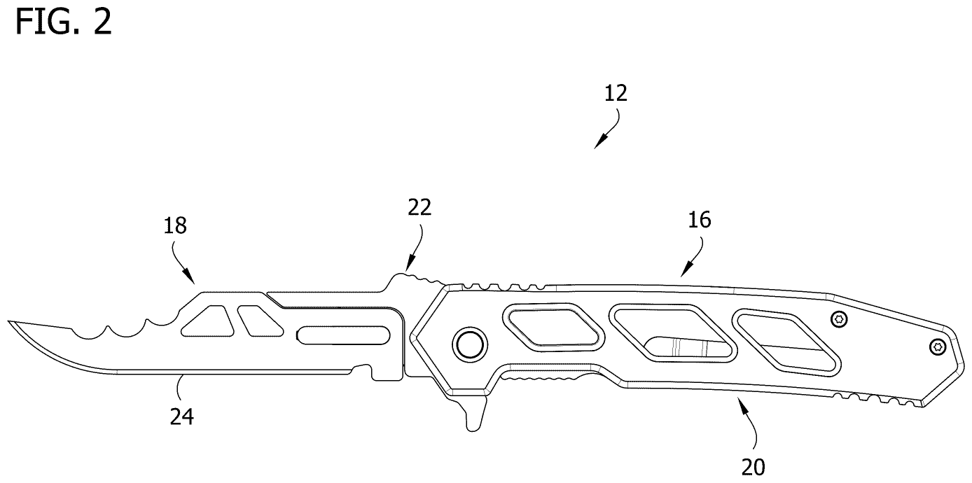

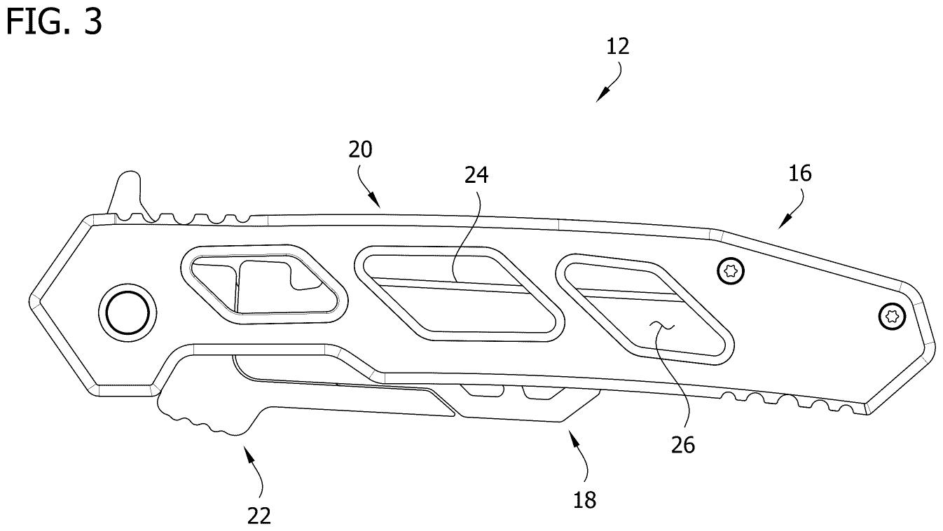

Referring to FIGS. 2-5, the blade support 16 includes a handle 20 and a blade carrier 22. The handle 20 is sized and shaped to be grasped by a user to hold the knife 12. The blade carrier 22 is connected to a distal end portion of the handle 20. The blade carrier 22 makes a connection (e.g., releasable connection) with a blade 18 to mount the blade on the blade support 16. In the illustrated embodiment, the blade carrier 22 is pivotably connected (e.g., pivot connection) to the handle 20 to permit the blade 18 and blade carrier to be pivoted between an operational or deployed position (FIG. 2) and a stowed position (FIG. 3). FIG. 2 shows the knife 12 in an operational or deployed configuration, and FIG. 3 shows the knife in a stowed configuration. In the stowed position/configuration, a cutting edge 24 of the blade 18 is located in a blade recess or cavity 26 in the handle 20. In the operational position/configuration, the cutting edge 24 of the blade 18 is exposed for use. It will be appreciated that the blade carrier 22 may not be pivotable with respect to the handle 20 (e.g., fixed blade or non-folding knife) without departing from the scope of the present disclosure.

The blades 18 are interchangeably mountable on the blade support 16 (specifically, the blade carrier 22). For example, when a first blade 18 mounted on the blade support 16 becomes dull, the first blade can be removed and replaced with a new second blade 18 rather than sharpen the first blade. In this manner, the blades 18 are known as disposable blades. The blade support 16 with a blade 18 thereon can be referred to generally as a knife assembly or knife 12.

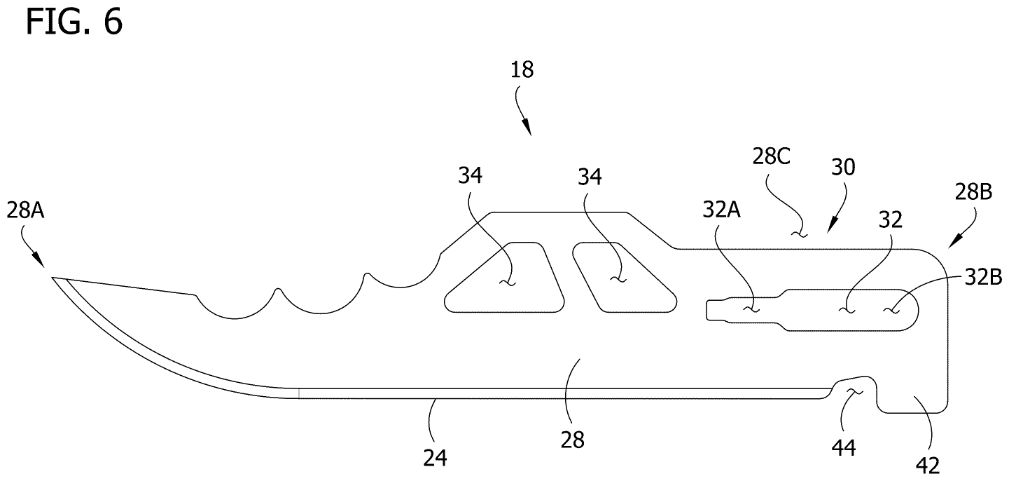

Referring to FIG. 6, the blades 18 of the illustrated embodiment are all identical. Accordingly, one blade 18 will now be described with the understanding the description applies to all the blades. The blade 18 includes a blade body 28 having a distal end portion 28A including a tip or distal end and a proximal end portion 28B including a proximal end. The cutting edge 24 extends from the tip toward the proximal end. In the illustrated embodiment, the cutting edge 24 is a straight edge, although other types of cutting edges such as serrated edges or combination edges can be used without departing from the scope of the present disclosure.

The blade 18 includes a blade connector 30 configured to connect with a blade carrier connector 36 (described below) to mount the blade on the blade carrier 22. In the illustrated embodiment, the blade connector 30 includes a keyhole 32 (broadly, opening or graduated opening). The keyhole 32 is provided in the blade body 28 in the proximal end portion 28B of the blade 18 toward the proximal end of the blade. A distal segment 32A of the keyhole 32 (broadly, keying portion or profile) is sized and shaped to closely conform to a keying profile of the blade carrier connector 36. A proximal segment or end 32B of the keyhole 32 is configured to closely conform to a keeper 40C of the blade carrier connector 36 when the blade carrier connector 36 and blade connector 30 are mated. The perimeter of the keyhole 32 is enclosed by the blade body 28. Thus, the proximal and distal ends of the keyhole 32 are closed. Other configurations of openings or connectors can be used without departing from the scope of the present disclosure.

The blade 18 includes one or more blade holder openings 34 sized and shaped to receive blade holder protrusions or retainers 84 of the blade case 14 for holding the blade in a blade tool compartment 62 of the blade case. Blade holder openings 34 are provided in the blade body 28. In the illustrated embodiment, the blade 18 includes two blade holder openings 34, although other numbers (e.g., one, three, four, etc.) and other configurations (e.g., other shapes/sizes) of blade holder openings can be used without departing from the scope of the present disclosure. The blade holder openings 34 are disposed between the tip of the blade 18 and the blade connector 30. In the illustrated embodiment, the blade holder openings 34 are disposed near a center point of a length of the blade 18.

The blade 18 includes a tab 42. The tab 42 extends from the proximal end portion 28B of the blade body 28 (broadly, the tab may be considered part of the blade body). The tab 42 assists a user in flexing the blade 18 to facilitate removal of the blade from the blade carrier 22. The tab 42 is integrally formed with the blade body 28. The tab 42 is disposed on the cutting edge side of the blade 18 and protrudes in the cutting direction beyond the cutting edge 24. The tab 42 is separated from the cutting edge 24 (e.g., a proximal end thereof) by a choil or notch 44, formed by the blade body 28. This separates the tab 42 from the cutting edge 24 to provide a measure of safety that reduces the likelihood of a user's finger coming into contact with the cutting edge when the finger engages the tab. The blade 18 is resiliently deformable and flexible. In an at-rest, undeformed state, the blade 18 is substantially planar. The user can engage the tab 42 to bend the blade 18 out of plane (e.g., bend the proximal end portion 28B out of plane with the distal end portion 28A).

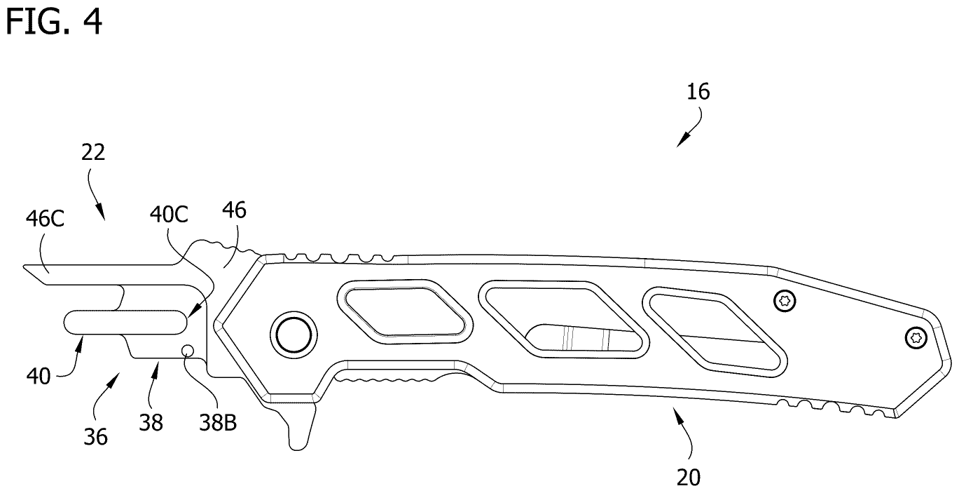

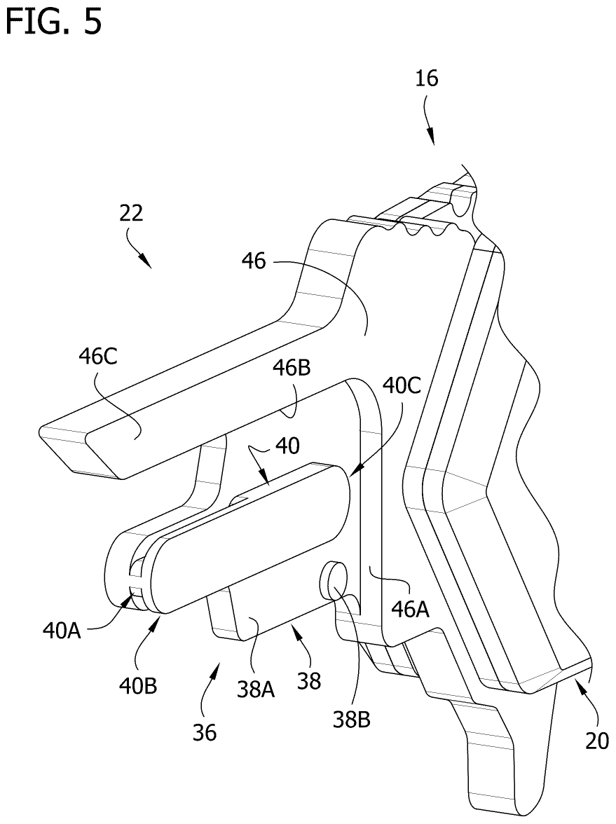

Referring to FIGS. 4-6, the blade carrier 22 includes a blade carrier connector 36. The blade carrier connector 36 includes a blade brace (broadly, support) 38 and a blade retainer 40. In the illustrated embodiment, the blade retainer 40 is provided in the form of a key (broadly, “protrusion”) that is receivable in the keyhole 32 of the blade 18 for mounting the blade on the blade carrier 22. The blade retainer 40 includes a first distal portion 40A adjacent the blade brace 38 that has a contoured outer surface defining a keying profile to correspond to the keying portion 32A of the keyhole 32 in the blade 18. The blade retainer 40 includes a second distal outer portion 40B that overlies opposite edge margins defining the keyhole 32 (e.g., keying portion 32A thereof) when the blade 18 is connected to the blade carrier 22. Together, the blade brace 38 and blade retainer 40 (e.g., first and second distal portions 40A, 40B) form grooves (FIG. 5) of the blade carrier 22 that receive the opposite edge margins defining the keyhole 32 (e.g., keying portion 32A thereof) when the blade 18 is connected to the blade carrier 22. The blade retainer 40 includes a third proximal portion or end 40C that serves as a keeper (e.g., keeper portion) when the blade 18 is connected to the blade carrier 22 to hold the blade on the blade carrier. The blade carrier connector 36 mates with the blade 18 and braces the blade to form a secure and stable connection of the blade to the blade carrier 22 to form the knife 12. For example, and without limitation, the blade carrier can be formed of metal (e.g., steel) or another suitable material. It will be appreciated although in the illustrated embodiment the blade carrier 22 comprises a male connecting component and the blade 18 includes a female connecting component, the locations of the male/female connecting components can be switched without departing from the scope of the present disclosure.

The blade brace 38 includes a blade bracing surface 38A arranged to engage a side face of the blade 18 to brace the blade when the blade is mounted on the blade carrier 22. The blade bracing surface 38A is planar. The blade brace 38 may also include a bracing projection 38B extending up from the blade bracing surface 38A. The bracing projection 38B is arranged to engage the blade body 28 (e.g., proximal end portion 28B thereof) to slightly deform the blade body out of plane when the blade 18 is mounted on the blade carrier 22. This slight bending of the blade 18 out of plane rigidifies the connection between the blade and blade carrier 22, by reducing the ability for the blade to move (e.g., wiggle, shake, shift) relative to the blade carrier. The distance the bracing projection 38B extends from the blade bracing surface 38A is less than the distance the blade retainer 40 extends from the blade bracing surface. This ensures the keeper 40C of the blade retainer 40 remains able to secure the blade 18 on the blade carrier 22.

In the illustrated embodiment, the blade carrier 22 is sized and shaped to correspond to and follow a portion of a perimeter edge of the blade 18. This creates a more visually appealing appearance of the knife 12. The blade carrier 22 includes a blade edge cover 46 sized and shaped to match a portion of the perimeter edge of the blade 18. The blade edge cover 46 covers a top perimeter edge and proximal perimeter edge of the blade 18 when the blade is mounted to the blade carrier 22. The blade edge cover 46 includes a first cover segment or edge 46A that covers, corresponds to, is in close proximity with (e.g., less than ⅛ inch), and faces the proximal perimeter edge of the blade 18 when the blade is mounted to the blade carrier 22. The blade edge cover 46 includes a second cover segment or edge 46B that covers, corresponds to, is in close proximity with (e.g., less than ⅛ inch), and faces a proximal portion of the top perimeter edge of the blade 18 when the blade is mounted to the blade carrier 22. In the illustrated embodiment, the second cover segment 46B is formed (at least in part) by a cover projection 46C of the blade edge cover 46. The cover projection 46C is received in a perimeter recess 28C of the blade body. The perimeter recess 28C is defined by the top perimeter edge of the blade 18. The top perimeter edge of the blade 18 bounds a distal end and bottom of the perimeter recess 28C, with the proximal end and top of the perimeter recess being open. Desirably, when mounted to the blade carrier 22, an intermediate portion of the top perimeter edge of the blade 18 (that is distal of the perimeter recess 28C) is aligned with a top edge of the cover projection 46C, to create a visually appealing appearance (FIG. 2).

Still referring to FIGS. 4-6, the blade 18 can be installed on the blade carrier 22 by manipulating the blade and blade carrier to mate the blade retainer 40 with the keyhole 32. The blade 18 is temporarily resiliently deformed to permit the connection to be formed. The blade 18 has an at-rest configuration in which the blade body 28 lies substantially in a plane, and the blade has a resiliently deformed configuration in which the blade body is flexed/arched to move the proximal segment 32B of the keyhole 32 out of plane with respect to the keying portion 32A of the keyhole. In a first step of installing the blade 18 on the blade carrier 22, the user locates the blade connector 30 in registration with the blade carrier connector 36. The two connectors 30, 36 are then moved closer together to begin receiving the keying profile of the blade retainer 40 in the keyhole 32. The blade 18 is generally moved in the proximal direction to insert the blade retainer 40 into the keyhole 32. The blade 18 may be flexed to facilitate entry of the blade retainer 40 into the keyhole 32. As the blade 18 is moved proximally to receive the blade retainer 40, the keying profile moves into engagement with the keying portion 32A of the keyhole 32 for close conforming fitment to securely hold the blade. As the keying profile of the blade retainer 40 moves toward engagement with the keying portion 32A of the keyhole 32, the outer distal portion 40B of the blade retainer moves into overlying position with respect to the blade body 28 such that opposing edge margins defining the keyhole 32 are located between the blade brace 38 (specifically, blade bracing surface 38A) and the outer distal portion 40B of the blade retainer 40. In other words, the opposite edge margins of the blade body 28 defining the keyhole 32 slide into the grooves of the blade carrier 22. When the keying profile is received in the keying portion 32A of the keyhole 32, the proximal segment 32B of the keyhole is located to receive the proximal end or keeper 40C of the blade retainer 40 and does so when the proximal end portion 28B of the blade body 28 is permitted to resiliently return toward its at-rest configuration. By returning towards its at-rest configuration, the edge of the blade body 28 that defines the proximal end of the keyhole 32 becomes aligned (e.g., axially aligned) with the keeper 40C such that the blade body will engage the keeper and inhibit disconnection should the blade 18 be tried to move distally with respect to the blade support 16. The blade 18 is secured in stable connection to the blade carrier 22 by the keying profile of the blade retainer 40 being received in the keying portion 32A of the keyhole 32, the opposite edge margins of the keyhole being sandwiched between the overlying outer distal portion 40B of the blade retainer 40 and the blade brace 38, and the keeper 40C of the blade retainer 40 being in close conforming fitment in the proximal segment or end 32B of the keyhole 32. Other configurations and types of connections can be used without departing from the scope of the present disclosure.

To remove the blade 18 from the blade carrier 22, the user can use the tab 42 of the blade. For example, a user may hold the handle 20 in one hand and use a finger of their other hand to press the tab 42 outward away from the blade brace 38, to move the proximal end portion 28B of the blade body 28 out of plane which causes the proximal end 32B of the keyhole 32 to become misaligned with the keeper 40C of the blade retainer 40. After the proximal end 32B of the keyhole 32 is sufficiently free of the blade retainer 40, the blade 18 can slide longitudinally in a distal direction to remove the remainder of the blade retainer from the keyhole and thus remove the blade from the blade carrier 22. When the blade 18 is mounted on the blade carrier 22, the tab 42 (e.g., a free end thereof) is exposed to be pressed by the finger of a user for flexing the blade to facilitate disconnection. In other words, when the blade 18 is mounted on the blade carrier 22, the tab 42 extends below the blade brace 38.

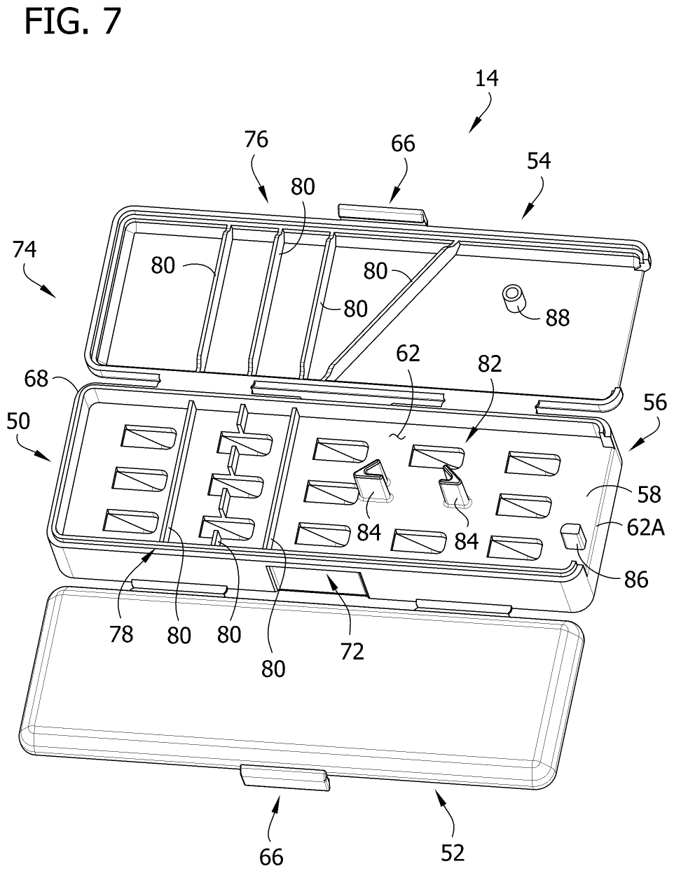

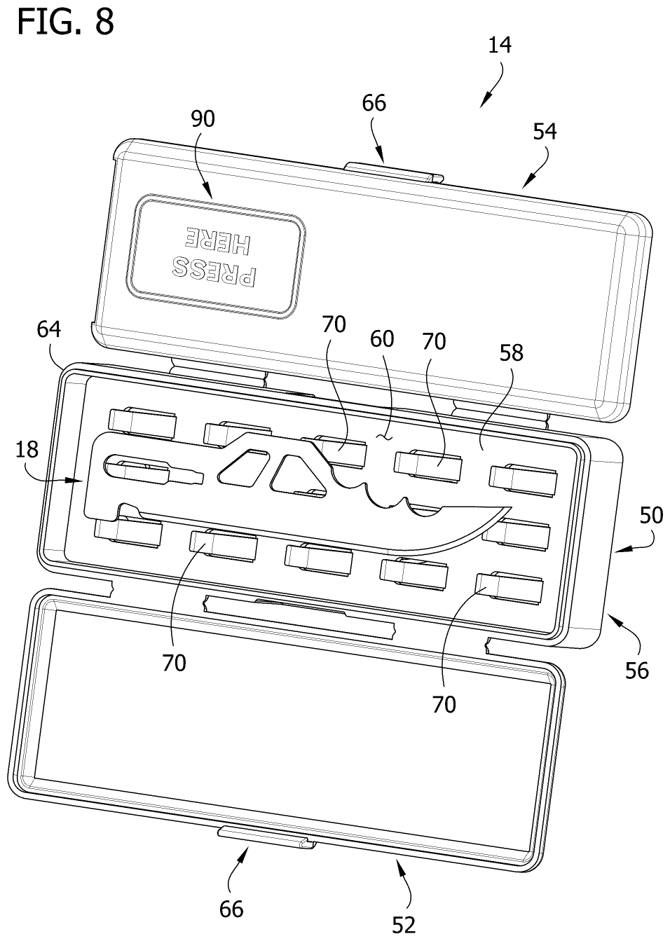

Referring to FIGS. 7 and 8, the blade case 14 can serve a blade storage purpose and a blade installation/removal purpose (blade tool). The blade case 14 includes a case body 50 and first and second covers or lids 52, 54 connected to the case body (such as by one or more hinges (e.g., living hinges)). The case body 50 comprises a housing or base 56 including a partition, wall, or web 58 that separates a blade storage compartment 60 of the housing from a blade tool compartment 62 of the housing. The housing 56 includes a first peripheral wall 64 extending upward from the web 58 that together with the web defines the blade storage compartment 60 that can be closed by the first cover 52. The first cover 52 includes a retainer or latch 66 engageable with a keeper 72 (e.g., shoulder or lip) on the housing 56 to retain the first cover in the closed position. The housing 56 includes a second peripheral wall 68 extending downward from the web 58 that with the web defines the blade tool compartment 62 that can be closed by the second cover 54. The second cover 54 includes a retainer or latch 66 engageable with a keeper 72 (e.g., shoulder or lip) on the housing 56 to retain the second cover in the closed position. In the illustrated embodiment, the first and second peripheral walls 64, 68 are aligned with one another such that together the first and second peripheral walls may be considered a single peripheral wall that extends around the perimeter of the web 58.

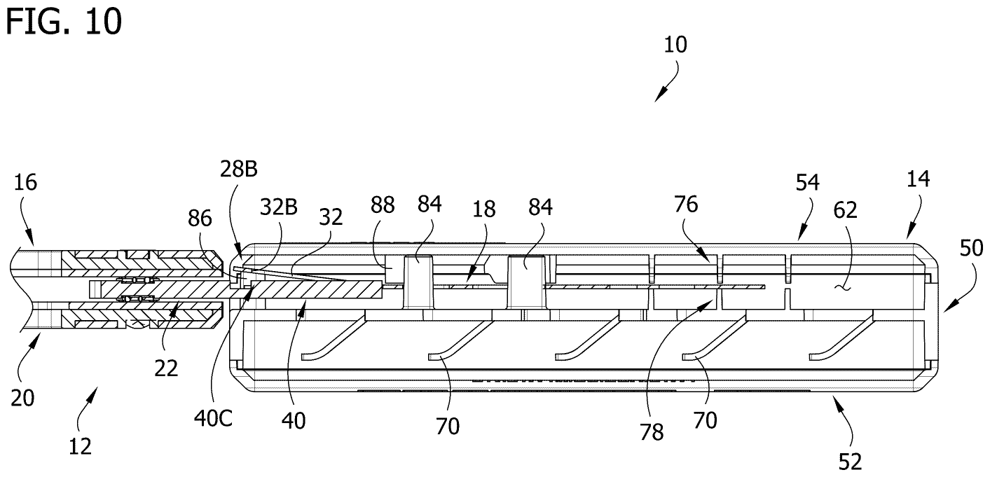

Referring to FIG. 8, the blade storage features of the blade case 14 will now be discussed. The blade case 14 includes a blade brace (e.g., blade storage brace) arranged to brace or push one or more spare (e.g., loose) blades 18 against the first cover 52, to prevent the spare blades from moving (e.g., rattling) around in the blade storage compartment 60. The web 58 includes a plurality of resiliently deformable protrusions 70 extending into the blade storage compartment 60. The blade storage brace comprises the protrusions 70. The protrusions 70 are spaced and arranged to form a segmented bed for receiving one or more blades 18 to be stored in the blade storage compartment 60. In the illustrated embodiment, the protrusions 70 are provided in the form of fingers extending at an angle (relative to the web 58) into the blade storage compartment 60. The fingers are sized and shaped such that distal ends of the fingers (e.g., fingertips) are adjacent to, and may even engage, the underside of the first cover 52 when the first cover is closed (FIG. 10). The arrangement is such that when a spare blade 18 or stack of multiple spare blades is located on the fingers, and the first cover is closed, the first lid pushes the blades 18 toward the web 58, causing the fingers to resiliently deform and flex. The fingertips move toward the web 58. With the first cover 52 closed, the one or more blades 18 in the blade storage compartment 60 are sandwiched between the protrusions 70 and the first cover. When the first cover 52 is held in closed position by the retainer 66, the fingers continually push the blade(s) 18 against the underside of the first cover. Thus, the blades 18 are held in position and do not rattle inside the blade storage compartment 60. Other types of resilient protrusions can be used without departing from the scope of the present disclosure. The fingers can deflect sufficiently to permit several blades 18 (e.g., six) in a stack to be received in the blade storage compartment 60. When the first cover 52 is opened, the fingers resiliently return toward their at-rest configurations (FIG. 10) from their resiliently deformed configurations. The protrusions 70 are arranged on the web 58 such that at least a portion of the protrusions will engage the stack of blades 18 when the blades are placed in the blade storage compartment 60. In the illustrated embodiment, the protrusions 70 are arranged in a 3x5 grid that substantially covers the web 48, although other configurations can be used without departing from the scope of the present disclosure.

Referring to FIG. 7, the blade tool features of the blade case 14 will now be discussed. The blade tool compartment 62, on the other side of the housing 56 from the blade storage compartment 60, can be used for installing and/or removing a blade 18 from the blade support 16. The blade tool compartment side of the housing 56 in conjunction with the second cover 54 can be referred to broadly as a blade tool 74. The blade tool 74 includes blade engagement structure that holds the blade 18 in position (in the blade tool compartment 62) and flexes the blade to permit the installation and removal of the blade from the blade support 16.

The blade engagement structure includes first and second blade braces 76, 78 arranged to engage opposite sides or faces of the blade 18 when the blade is in the blade tool compartment 62. The first blade brace 76 is carried by the second cover 54 and the second blade brace 78 is carried by the housing 56 (e.g., web 58). In general, the first and second blade braces 76, 78 are located on opposite sides of the blade tool compartment 62 to locate the blade 18 between the web 58 and the underside of the second cover 54 (e.g., position the blade heightwise in the blade tool compartment). The first and second blade braces 76, 78 are arranged to engage the distal half (e.g., distal end portion 28A) of the blade 18. The first and second blade braces 76, 78 are arranged such that they at least partially align to engage the same section of the blade. In the illustrated embodiment, the first and second blade braces 76, 78 each comprise a plurality of ribs 80 (broadly, protrusions). The most of the ribs 80 extend generally perpendicularly to a longitudinal axis of the housing 56. One rib 80 of the first blade brace 76 extends at a skew angle relative to the longitudinal axis. The ribs 80 of the first blade brace 76 extend from an underside of the second cover 54. The ribs 80 of the second blade brace 78 extend from the web 58.

The blade engagement structure includes a blade holder or positioner 82 for positioning the blade 18 within the blade tool compartment 62. In the illustrated embodiment, the blade holder 82 includes two holding or positioning protrusions 84 (broadly, at least one protrusion). Each holding protrusions 84 is sized and shaped to be received in one of the blade holder openings 34 of the blade 18 to hold the blade in position in the blade tool compartment 62 (FIG. 1). The at least a portion of the exterior of the holding protrusions 84 match the size and shape of corresponding portions of the blade holder openings 34 of the blade 18 to position the blade 18 in the blade tool compartment 62 and limit the movement of the blade in a direction parallel to the web 58 in the blade tool compartment. Each holding protrusion 84 is connected to and extends from the web 58.

The blade engagement structure includes first and second flexing protrusions 86, 88 (broadly, pusher, lug, or boss). The flexing protrusions 86, 88 engage opposite sides or faces of the blade at offset locations with respect to each other (e.g., the flexing protrusions are offset along the longitudinal axis of the housing 56) to cause the blade to flex to permit connection and disconnection of the blade 18 with the blade carrier 22. The flexing protrusions 86, 88 cause the blade to flex to permit installation and removal of the blade retainer 40 of the blade carrier 22 into and out of the keyhole 32 of the blade 18. The first flexing protrusion 86 is arranged to engage or press the tab 42 of the blade 18. The first flexing protrusion 86 is connected to and extends from the web 58. The second flexing protrusion 86 is arranged to engage or press the proximal end portion 28B of the blade 18 at a location distally from the tab 42, and more desirably distally from the keyhole 32. Accordingly, the second flexing protrusion 88 is located distally along the longitudinal axis of the housing 56 of the first flexing protrusion 86. The second flexing protrusion 88 is connected to and extends from the second cover 54 (e.g., the underside thereof).

Referring to FIG. 10, the configuration of the blade engagement structure is such that when the blade 18 is positioned in the blade tool compartment 62, with the blade holding protrusions 84 received in the blade holder openings 34 of the blade 18, and the second cover 54 is closed, the first and second flexing protrusions 86, 88 cause the proximal end portion 28B of the blade 18 to flex. This configures the keyhole 32 of the blade 18 for receipt and removal of the blade retainer 40 of the blade carrier 22. The blade tool compartment 62 has an open end or opening 62A (adjacent the first flexing protrusion 86) sized and shaped to permit the blade carrier 22 to be inserted into the blade tool compartment to engage the blade carrier with a flexed blade 18 and to permit the blade carrier to be removed from the blade tool compartment to disengage the blade carrier with a flexed blade. During the flexing, the first and second blade braces 76, 78 (particularly, the second blade brace) act as an anchor that holds the distal end portion 28A of the blade 18 in position to allow the flexing protrusions 86, 88 to flex the blade. Without this anchor, the blade 18 would not flex or would not flex sufficiently when the second cover 54 is closed. As shown in FIG. 1, the blade 18 (e.g., a length thereof) extends generally parallel to the longitudinal axis of the housing 56 (broadly, blade tool 74) when the blade is positioned in the blade tool compartment 62.

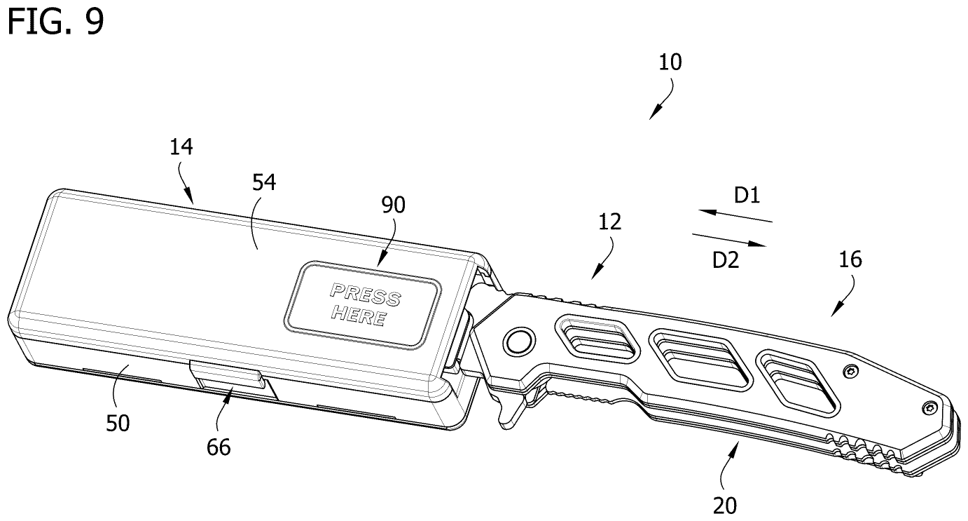

To connect a blade 18 to the blade support 16, the user opens the second cover 54 and positions the blade (which may have been previously removed from the blade storage compartment 60) in the blade tool compartment 62. The blade holder openings 34 are aligned with the blade holding protrusions 84 and then the blade 18 is moved toward the web 58, such that the blade holding protrusions extend through the blade holder openings. The second cover 54 is then closed, which causes the flexing protrusions 86, 88 to engage and flex the blade 18, configuring the keyhole 32 of the blade 18 for receipt of the blade retainer 40 of the blade carrier 22. The blade carrier 22, in the operational position, is inserted into the opening 62A of the blade tool compartment 62. The blade support 16 is moved in an insertion direction D1 (FIG. 9), parallel to the longitudinal axis of the housing 56. When the blade carrier 22 is pushed sufficiently into the blade tool compartment 62, the keying profile of the blade retainer 40 becomes seated on the keying portion 32A of the keyhole 32, as described above. The blade holding protrusions 84 (specifically, the blade holding protrusion closest to the first flexing protrusion 86) received in the blade holder openings 34 of the blade 18 prevent the blade from moving with the blade carrier 22 (e.g., from moving distally in the blade tool compartment 62 as the blade carrier is inserted into and pressed against the blade). In other words, the blade holding protrusions 84 keep the blade stationary (e.g., at a fixed position along the longitudinal axis of the housing 56) as the blade carrier 22 is connected to the blade. After the blade retainer 40 is seated in the keyhole 32, the second cover 54 is opened. The flexing protrusions 86, 88 separate from each other, permitting the proximal end portion 28B of the blade 18 to return toward its at-rest configuration, thus securing the proximal end 40C of the blade retainer 40 in the proximal portion 32B of the keyhole 32, completing installation of the blade on the blade carrier 22. The second cover 54 may include indicia 90 on the exterior of the cover defining a press area or button for a user to press if needed to sufficiently flex the blade 18 (if simply closing the second cover is insufficient). In the illustrated embodiment, the indicia 90 comprises a border and the phrase “press here,” although other configurations may be used without departing from the scope of the present disclosure. The indicia 90 is aligned with (e.g., overlies) the second flexing protrusion 88, such that pressing the button results in moving the second flexing protrusion toward the web 58 to further flex the blade 18.

To remove a blade 18 from the blade support 16, the user opens the second cover 54 and positions the blade in the blade tool compartment 62 such that the blade holding protrusions 84 are received in the blade holder openings 34 of the blade. The blade holding protrusions 84 are located to dictate a position of the blade 18 in the blade tool compartment 62 so the flexing protrusions 86, 88 will engage the blade to flex the blade. After the blade 18 receives the blade holding protrusions 84, the second cover 54 is closed. As the second cover 54 is closed, the flexing protrusions 86, 88 push on the opposite sides of the blade to cause the blade to flex, which displaces the proximal end 32B of the keyhole 32 from the proximal end 40C of the blade retainer 40. As shown in FIG. 10, this arranges the blade 18 and keyhole 32 such that when the user pulls on the handle 20 in a removal direction D2 (FIG. 9) (a direction tending to pull the blade carrier out of the blade tool compartment 62), the blade retainer 40 is removed from the keyhole 32, disconnecting the blade carrier from the blade. The removal direction D2 is opposite of the insertion direction D1 and parallel to the longitudinal axis of the housing 56. The blade holding protrusions 84 (specifically, the blade holding protrusion furthest from the first flexing protrusion 86) received in the blade holder openings 34 of the blade 18 prevent the blade from moving with the blade carrier 22 (e.g., from moving proximally in the blade tool compartment 62 as the blade carrier is withdrawn from the blade). In other words, the blade holding protrusions 84 keep the blade stationary (e.g., at a fixed position along the longitudinal axis of the housing 56) as the blade carrier 22 is disconnected from the blade. The second cover 54 can remain closed to hold the removed blade 18. Alternatively, the second cover 54 can be opened, and the blade 18 can be disposed or moved to the blade storage compartment 60. It will be appreciated that the blade tool 74 provides a safe way for installing/removing the blade 18 from the blade carrier 22. The cutting edge 24 of the blade 18 is enclosed in the blade tool compartment 62 while applying force to the blade to flex the blade to a configuration that permits installation/removal. It will be appreciated that the blade 18 can be installed/removed without the use of the blade tool 74, as describe herein.

In the illustrated embodiment, the blade storage compartment 60 and blade tool 74 are provided as parts of the same blade case 14. It will be appreciated that the blade storage and blade tool aspects can be separated (e.g., incorporated in separate structures or housings) without departing from the scope of the present disclosure.

It will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A knife system comprising:
a blade including a cutting edge, a blade connector, and a blade holder opening;
a blade support including a handle and a blade carrier, the blade carrier configured to releasably connect to the blade connector of the blade to mount the blade to the blade support;
a blade tool including a blade tool compartment configured to receive the blade, the blade tool configured to flex the blade to enable the blade carrier to connect to the blade connector of the blade to mount the blade to the blade support and to enable the blade carrier to disconnect from the blade connector of the blade to separate the blade and the blade support, the blade tool including a blade holder sized and shaped to be received in the blade holder opening of the blade to prevent the blade from moving with the blade support when the blade carrier is connected to the blade and when the blade carrier is disconnected from the blade.

2. The knife system of claim 1, wherein the blade has opposite first and second faces, and wherein the blade tool includes a first flexing protrusion configured to engage the first face of the blade to flex the blade.

3. The knife system of claim 2, wherein the blade tool includes a second flexing protrusion configured to engage the second face of the blade to flex the blade.

4. The knife system of claim 3, wherein the blade holder is arranged relative to the first and second flexing protrusions such that the blade is positioned to be engaged by the first and second flexing protrusions when the blade holder is received in the blade holder opening of the blade.

5. The knife system of claim 3, wherein the first and second flexing protrusions are offset along a longitudinal axis of the blade tool, a length of the blade being generally parallel to the longitudinal axis of the blade tool when blade is received in the blade tool compartment and the blade holder is received in the blade holder opening of the blade.

6. The knife system of claim 3, wherein the blade tool includes a housing and a lid defining the blade tool compartment, the first flexing protrusion being connected to the housing and the second flexing protrusion being connected to the lid.

7. The knife system of claim 6, wherein the lid is moveable between an open positon and a closed position, the lid configured to bring the second flexing protrusion into contact with the second face of the blade to flex the blade as the lid is moved from the open position toward the closed position.

8. The knife system of claim 2, wherein the blade includes a tab forming a portion of the first face, the first flexing protrusion is configured to engage the tab of the blade to flex the blade.

9. The knife system of claim 1, further comprising a blade case including the blade tool and a blade storage compartment configured to store a plurality of replacement blades.

10. The knife system of claim 1, wherein the blade connector of the blade comprises a keyhole.

11. The knife system of claim 10, wherein the blade carrier comprises a key sized and shaped to be received in the keyhole of the blade.

12. The knife system of claim 11, wherein the key and the keyhole have matching keying profiles for close conforming fitment between the key and the keyhole.

13. The knife system of claim 1, wherein the blade tool compartment has an open end sized and shaped to permit the blade carrier to be inserted into the blade tool compartment for connecting the blade carrier to the blade connector of the blade and to permit the blade carrier to be removed from the blade tool compartment for disconnecting the blade carrier from the blade connector of the blade.

14. The knife system of claim 1, wherein the blade holder opening is a first blade holder opening, the blade including a second blade holder opening, wherein the blade holder comprises a first blade holder protrusion and a second blade holder protrusion, the first blade holder protrusion being sized, shaped, and arranged to be received in the first blade holder opening of the blade and the second blade holder protrusion being sized, shaped, and arranged to be received in the second blade holder opening of the blade.

15. A knife comprising:
a blade support including a handle and a blade carrier, the blade carrier including a key;
a blade comprising:
a blade body having a proximal end portion and a distal end portion, the blade body being resiliently flexible;
a cutting edge extending from the distal end portion toward the proximal end portion;
a keyhole defined by the blade body in the proximal end portion, the keyhole being sized and shaped to receive the key of the blade carrier to connect the blade to the blade support; and
a tab extending from the proximal end portion of the blade body, the tab being disposed on a cutting edge side of the blade, the tab being configured to be exposed when the blade is mounted to the blade support to enable a finger to press the tab to flex the blade for disconnecting the blade from the blade support.

16. The knife of claim 15, wherein the blade carrier includes a blade brace configured to engage a face of the blade when the blade is connected to the blade support, the tab being configured to permit the finger to press the tab to flex the blade away from the blade brace for disconnecting the blade from the blade support.

17. The knife of claim 15, further comprising a choil defined by the blade body, the choil disposed between the cutting edge and the tab.

18. A blade case comprising:
a housing having a blade tool compartment and a blade storage compartment separated by a web of the housing, the blade tool compartment being sized and shaped to store a plurality of blades, the blade tool compartment being sized and shaped to receive one of the blades of the plurality of blades;
a first lid supported by the housing and configured to close the blade storage compartment;
a second lid supported by the housing and configured to close the blade tool compartment; and
blade engagement structure configured to flex said one blade of the plurality of blades received in the blade tool compartment to enable a blade support to be connected to and disconnected from said one blade.

19. A blade for a knife, the blade comprising:
a blade body having a proximal end portion and a distal end portion, the blade body being resiliently flexible;
a cutting edge extending from the distal end portion toward the proximal end portion;
a keyhole defined by the blade body in the proximal end portion;
a blade holder opening defined by the blade body, the blade holder opening disposed along a length of the blade body between the keyhole and distal end portion of the blade body.

20. The blade of claim 19, further comprising a tab extending from the proximal end portion of the blade body, the tab being disposed on a cutting edge side of the blade, a proximal end of the cutting edge being spaced apart from the tab.
